(19) United States
(12) Patent Application Publication
(10) Pub. No.: US 2016/0038969 A1
(43) Pub. Date: Feb. 11, 2016

(54) FILM PRESS

(71) Applicant: VOITH PATENT GMBH, Heidenheim (DE)

(72) Inventor: MATTHIAS SCHMITT, MUENCHEN (DE)

(73) Assignee: VOITH PATENT GMBH, HEIDENHEIM (DE)

(21) Appl. No.: 14/782,370

(22) PCT Filed: Mar. 26, 2014
(86) PCT No.: PCT/EP2014/056045

§ 371 Date: Oct. 5, 2015

(30) Foreign Application Priority Data
Apr. 5, 2013 (DE) 10 2013 206 091.2

(51) Int. Cl. B05D 1/28; B05C 1/08; B05D 3/00

(52) U.S. Cl. CPC B05D 1/28; B05D 3/002; B05C 1/08

(57) ABSTRACT

A film application mechanism applies a pasty or fluid coating medium to a running fibrous material web, particularly a paper or cardboard web. At least one roller of a roller pair is an application roller, for transferring the coating medium provided in the form of a film on the application roller to one side of the fibrous material web. An application device and a doctor blade element are associated with the application roller such that the coating material is first applied in excess to the application roller upstream of the first nip by the application device and then removed in part in a second nip by the doctor blade element which forms the second film-forming nip with the application roller. Pressure sensors for determining a pressure profile transversely to the machine direction in the first and second nips are embedded in the elastic covering of the application roller.

The invention relates to a film application unit for applying a liquid or pasty coating medium to one or both sides of a fibrous web, in particular a paper or cardboard web, according to the preamble of patent claim 1, and to a method according to the preamble of patent claim 13.

In application units it is known from the prior art for the pressure profile in the nip through which the fibrous web is guided in order to apply the fluid or pasty coating medium, such as coating color or starch, to be measured. An application unit for directly applying a coating medium, in which for achieving uniform application of the coating medium to the fibrous web the pressure profile is measured in a nip formed between a support roller and an application unit, is thus known from DE11 2009 000 095, for example.

In indirect application units, such as film application units, for example, in which the coating medium by means of an application installation is first excessively applied to an application roller and then by means of a doctor element which together with the application roller forms a nip, such as a doctor bar or a doctor blade, for example, is again partially removed in the in order for a film to be configured from the medium prior to the film of the application roller in a further nip through which the fibrous web is guided being transferred from the application roller to that side of the fibrous web that comes in contact with the application roller, there is moreover the issue that the film which is provided on the respective application roller has to be configured as uniformly as possible in the machine cross direction, in order for a uniform amount of coating medium to be provided in the machine cross direction.

Moreover, in the employment of film application units there is generally the requirement of as little waste as possible when production is started up or is restarted after a web breakage, respectively, until the desired coating amount has been adjusted. High amounts of waste pending the reliable adjustment of the desired coating amount are encountered in particular in the case of film application units in fast-running paper machines, such as machines for graph paper or cardboard, since said fast-running machines experience a plurality of breakages of the fibrous web per day and during starting up or restarting production it often takes a plurality of seconds until the desired amount of coating medium in the machine cross direction is adjusted.

In film application units which are known from the prior art it has been attempted to date to draw conclusions pertaining to the distribution of pressure in the first and second nips by way of the pressure in hydraulic cylinders by way of which the two rollers in the film application unit, or the doctor element at the respective application roller, respectively, are brought to bear on one another. This procedure often proves to be inadequate however, since conclusions drawn from the pressures prevailing in the hydraulic cylinders can often be very inaccurate with respect to the actual pressure conditions in the first and second nips.

Moreover, in the case of simultaneous coating of both sides of the fibrous web it is currently not possible in a reliable manner for the amount of coating medium on each side of the web to be positively determined. Using the scanners which are presently available, it is only possible to ascertain after simultaneous bilateral coating whether or not the desired amount of coating medium has been applied in total. However, in the case of currently available film application units it can presently not be positively established on which side of the fibrous web an excess or a shortfall of coating medium has been applied.

It is the object of the present invention to propose a film application unit and a method for applying a pasty or fluid coating medium, by way of which the disadvantages described at the outset are eliminated or at least significantly reduced.

The object is achieved by a film application unit having the features of patent claim 1, and by the methods having the features of patent claims 13 and 17.

On account of the fact that the pressure profile by means of the pressure sensors, which in the machine cross direction are disposed beside one another and which are embedded in the elastic covering of one or both application roller(s) is ascertained prior to and/or during the application operation both in the first nip, i.e. the nip for transferring the film from the application roller to the fibrous web, as well as in the second nip, i.e. the nip for forming the film on the application roller, both pre-metering as well as transferring the film can be precisely measured and correspondingly controlled during the application operation. Furthermore, on account of the solution according to the invention, the desired amount of coating medium, that is to say the film thickness on the application roller, may be precisely adjusted even at the start of the coating operation, and the application operation may then be started up having the desired coating amount which is in particular homogenous in the machine cross direction, without unnecessary fibrous-web waste being produced.

In the case of simultaneous and bilateral application of a coating medium it is furthermore possible to precisely determine by way of the solution according to the invention what amount of coating medium is being applied to the respective side of the fibrous web.

Furthermore, the solution according to the invention distinguishes itself by its simplicity, since in the case of a film application unit for only unilateral application of coating medium to a fibrous web, for example, reliable conclusions pertaining to the distribution of pressure in both nips which are relevant to reliable coating may be drawn only by way of the sensors which are embedded in the elastic covering of the application roller.

In the context of the invention the term coating is to be understood as being not only the application of coating color to the fibrous web, but any application of a pigment-containing mixture and/or of a mixture for gluing, such as a starch-containing mixture, for example, to the fibrous web.

Advantageous design embodiments and refinements of the invention are stated in the dependent claims.

According to one preferred design embodiment of the invention an evaluation unit which communicates with the pressure sensors, and a display unit which communicates with the evaluation unit are provided, wherein the signals emanating from the pressure sensors are transmitted to the evaluation unit and are further processed in the evaluation unit in such a manner that said signals by means of the display unit is capable of being visually displayed as the pressure profile of the first and of the second nip. It is in particular conceivable in this context that the pressure profiles of the first and of the second nip(s) are displayed on one side of the display installation, for example in the same graphs. On account of the visual representation of the pressure signals as a pressure profile or as pressure profiles, a machine operator is able to monitor in a timely manner both film formation on the application roller as well as film transfer from the application roller to the fibrous web at a glance and to intervene in a corrective manner in the case of deviations from the nominal value.

Alternatively or additionally it is also conceivable for the evaluation unit to communicate with an acoustic signal generator which in the case of a deviation of the pressure values in the first and/or second nip emits an acoustic signal which is characteristic of the respective nip, so as to alert the machine operator to potential problems in the application operation. On account of acoustic signals being provided, the machine operator does not need to constantly keep an eye on the display installation but can attend to other tasks and will be informed if and when it is necessary to intervene in the application operation or to more closely monitor the application operation. In this way, the acoustic signals of the various nips may have different pitches, for example. This lets the machine operator decide which signal necessitates immediate intervention, instead of depending on which nip is particularly critical to the result in the specific production process.

Both rollers of the roller pair are preferably application rollers, so that the fibrous web by means of the film application unit which is embodied in this manner is simultaneously coated on both sides with the coating medium. Here, each of the two application rollers for providing in each case one film of the coating medium is assigned in each case one application installation and one doctor element which together with the respective application roller forms a second nip in such a manner that the coating medium which is present in the form of a film on the one application roller in the second nip is transferable from the one application roller to the one side of the fibrous web while the coating medium which is present in the form of a film on the other application roller in the second nip is transferred from the other application roller to the other side of the fibrous web.

In this context, pressure sensors which in each case communicate with the evaluation unit are preferably embedded in the elastic covering of both application rollers and in the machine cross direction are disposed beside one another, by means of which pressure sensors the pressure profile which is established in the machine cross direction of at least one second nip, in particular of both second nips, and of the first nip is ascertained. On account of the pressure profiles of both second nips which are established in the machine cross direction being ascertained, in particular the application amount to each side of the fibrous web may be determined in an individual and mutually independent manner. This is not possible with the scanners known to date, which are disposed after the film application unit which simultaneously applies to both sides and by which only the total amount of coating medium that has been collectively applied to both sides is determinable.

It should be noted that the composition of the coating medium which is applied to the one side of the fibrous web does not necessarily have to be the same as the composition of the coating medium which is applied to the other side of the fibrous web.

One further preferred embodiment of the invention provides that at least one of the application rollers, in the case of bilateral coating in particular both application rollers, has/have a signal generator which communicates with the evaluation unit and which emits signals which are characteristic of the rotational position of the application roller to the evaluation unit. On account thereof, the evaluation unit may in particular ascertain an assignment of the signals of the pressure sensors during passage of the pressure sensor(s) through the first and the second nip(s).

The film application unit is preferably operated in such a manner that a lower line force is measured by the pressure sensors in the second nip than in the first nip. Preferably, the line force measured in the second nip is lower than the line force measured in the first nip by a factor of at least 10, in particular by a factor of at least 15. The pressure sensors used here are in particular configured in such a manner that in the second nip a line force in the range of 0.01 kN/m to 10 kN/m is ascertainable, and in the first nip a line force in the range of 50 kN/m to 200 kN/m is ascertainable by said pressure sensors. If and when the doctor element is configured as a doctor blade, for example, the line force measured by means of the pressure sensors in the second nip may be between 0.5 kN/m and 5 kN/m. If and when the doctor element is configured as a doctor bar, for example, the line force measured by means of the pressure sensors in the second nip may be between 0.01 kN/m and 1 kN/m.

The pressure sensors are preferably fiber-optic sensors, in particular Bragg grating sensors. In comparison with piezo sensors for example, fiber-optic pressure sensors are in particular distinguished by modest dimensions and very high signal sensitivity. Even extremely low line forces may therefore be measured using fiber-optic sensors. Furthermore, fiber-optic sensors are distinguished by an extremely large bandwidth in terms of signal sensitivity, so that both very low as well as very high line force are measurable using said fiber-optic sensors.

According to one specific design embodiment of the invention, the one and/or other application roller(s) have/has a roller core the sleeve surface of which is surrounded by the covering, wherein the covering comprises a functional layer which is capable of being brought into contact with the coating medium, and when viewed in a radial direction of the covering a connecting layer which is disposed between the functional layer and the roller core, wherein the pressure sensors are disposed in the connecting layer or in the barrier region between the functional layer and the connecting layer. In order for the fibers to be embedded in a cost-effective and simple manner, it has proven advantageous for the fibers to be embedded between the two layers. The connecting layer is preferably harder than the functional layer, in particular harder than the functional layer by a factor of 10 to 100. On account thereof, it is ensured that pressure in the nip as a deformation may be readily spread in the functional layer and that the pressure sensors can positively detect the pressure in this way. On account of the harder configuration of the connecting layer which lies below the functional layer, the pressure sensors may be supported on the former, on account of which the sensitivity of the assembly is further amplified.

With a view to potential variants of the specific disposal of the pressure sensors in the covering and of the exemplary construction of coverings of application rollers, reference is made to the following table 1:

| | | | | | | Composite |
|---|---|---|---|---|---|---|
| | PU roller | Rubber roller | Rubber roller | Rubber roller | Rubber roller | roller |
| Functional | | | | | | |
| layer | | | | | | |
| Material | Polyurethane | Rubber | Rubber | Rubber | Rubber | Epoxy |
| | | | | | | resin/fibers |
| Thickness | 10-20 mm | 10-20 mm | 10-20 mm | 10-20 mm | 10-20 mm | 5-15 mm |
| Hardness | 60-100 | 60-100 | 60-100 | 60-100 | 60-100 Shore A | 80-90 Shore D |
| | Shore A | Shore A | Shore A | Shore A | | |
| Connecting | | | | | | |
| layer | | | | | | |
| 1st | Epoxy | Epoxy | Hard rubber | Hard rubber | Epoxy | Epoxy |
| connecting | resin/glass | resin/glass | | | resin/glass | resin/glass |
| layer | fiber | fiber | | | fiber | fiber |
| (D = | Thickness = | Thickness = 1-10 mm | Thickness = 1-10 mm | Thickness = 1-10 mm | Thickness = 1-10 mm | Thickness = 1-10 mm |
| thickness of | 1-10 mm | Hardness = | Hardness = | Hardness = | Hardness = 88-92 | Hardness = |
| layer) | Hardness = | 88-92 Shore D | 88-92 Shore D | 88-92 Shore D | Shore D | Shore D |
| | 88-92 Shore D | | | | | |
| 2nd | — | Rubber; | Rubber; | Rubber; | Hard rubber; | — |
| connecting | | Thickness = 1-10 mm | Thickness = 1-10 mm | Thickness = 1-10 mm | Thickness = 1-10 mm | |
| layer | | Hardness = 5-10 | Hardness = 5-10 | Hardness = 5-10 | Hardness = 76-86 | |
| | | P&J | P&J | P&J | Shore D | |
| 3rd | | | | | Rubber; | |
| connecting | | | | | Thickness = 1-10 mm | |
| layer | | | | | Hardness = 5-10 | |
| | | | | | P&J | |
| Position of | within 1st | barrier layer of | barrier layer of | within 1st or | barrier layer of | within 1st |
| sensors | connecting | 1st vs. 2nd | 1st vs. 2nd | 2nd | 1st vs. 2nd | connecting |
| | layer | connecting | connecting | connecting | connecting | layer |
| | | layer | layer | layer | layer | |

All pressure sensors of at least one application roller are preferably disposed along a straight line, the straight line in particular extending parallel with the rotation axis of the roller. Preferably, the pressure sensors in both application rollers are respectively disposed along a straight line, in particular along a straight line which is parallel with the rotation axis of the respective roller.

According to specific configurations of the present invention the doctor element is configured as a doctor bar or as a doctor blade, for example, such that the doctor bar or the doctor blade together with the sleeve surface of the application roller forms the second nip.

According to a further aspect of the invention, a method for applying a liquid or pasty coating medium to at least one side of a running fibrous web, in particular a paper or cardboard web, is proposed, in which method the coating medium prior to a second nip which is formed by the application roller and a doctor element is excessively applied to an application roller and in order for a film of the coating medium to be configured on the application roller is again partially removed in the second nip by the doctor element, and in which the film subsequently in a first nip is transferred by the application roller to a side of the fibrous web that comes into contact therewith. The method according to the invention is characterized in that the pressure profile which is established in the machine cross direction in the first nip and in the second nip is ascertained by means of pressure sensors which are embedded in the covering of the application roller.

The pressure profile in the first and second nips is preferably ascertained by means of pressure sensors which are embedded in the covering of the application roller, which in the machine cross direction are disposed beside one another, and which communicate with an evaluation unit.

According to one preferred refinement of the method, the fibrous web is simultaneously coated with the coating medium on both sides by means of two application rollers which are provided by a roller pair and between them form the first nip, wherein the coating medium is excessively applied to the respective application roller prior to a second nip which is formed by the respective application roller and a doctor element assigned thereto, and in order for a film of the coating medium to be configured on the respective application roller, is again partially removed in the respective second nip by the in each case assigned doctor element, and the film subsequently in the first nip is transferred by the respective application roller to that one side of the fibrous web which in each case comes into contact with said respective application roller, wherein the pressure profile which is established in the machine cross direction in the respective first nip and in the second nip is ascertained by means of pressure sensors which are embedded in the covering of the respective application roller.

The advantages of the two aforementioned embodiments of the method according to the invention have already been explained in an analogous manner above in the description of the corresponding device. Therefore, no further narrative in relation thereto is offered at this point.

The pressure profile is preferably ascertained prior to and/or during application of the coating medium to the fibrous web. By ascertaining the pressure profile in the first and second nips prior to the application operation, the coating amount may be precisely adjusted in advance, without waste being produced. On account thereof, the reject rate in particular in film application units which operate online, that is to say are integrated in the production line of the paper or cardboard machine, is significantly reduced, since the paper or cardboard machine during start up, for example after a machine stoppage, may directly run in production mode, without the paper or cardboard web having to be directed into the pulping unit until the precise adjustment of the application amount has been made.

Consequently, according to a third aspect of the invention, a method for manufacturing a coated fibrous web, in particular a paper, cardboard, or tissue web, is proposed, the method comprising the following steps:
forming the fibrous web from a fibrous mixture, using a headbox and a forming section;
dewatering the fibrous web in a pressing section;
pre-drying the fibrous web to a specific dry content;
an at least multiple application of a coating medium by means of the method as claimed in one of the preceding claims;
post-drying the coated fibrous web, wherein at least one application of a coating medium is performed in-line on the machine and manufacturing of the fibrous web is performed at a machine speed of 1200 meters/minute or more, in particular at a machine speed of 1500 meters/minute or more.

The fibrous web is preferably a printable fibrous web and the at least one application is an application in which a pigment-containing coating medium is applied to the fibrous web.

The invention will be explained in more detail below by means of schematic drawings, in which:

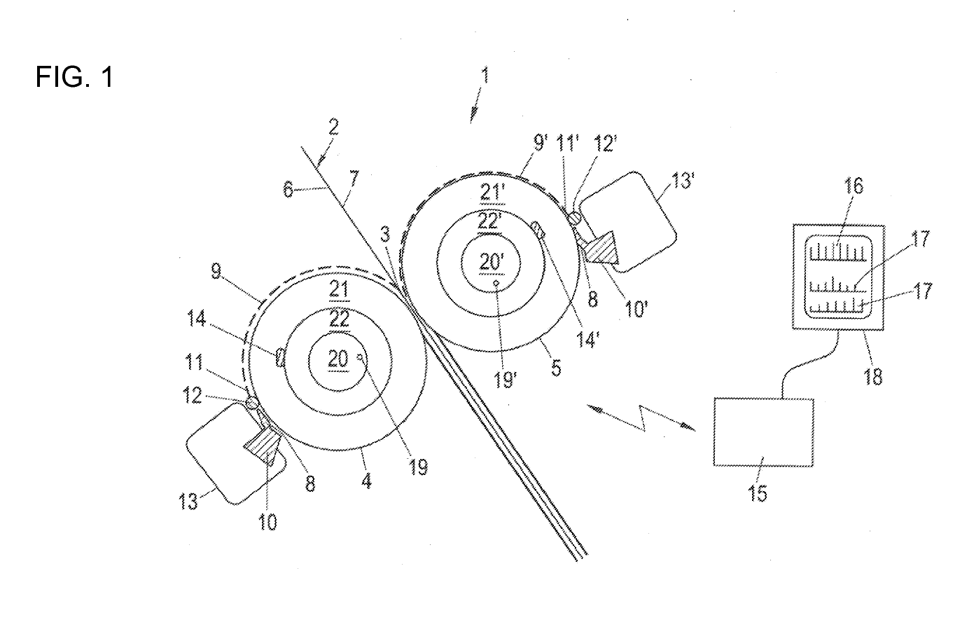

FIG. 1 shows a film application unit according to the invention, in the cross section;

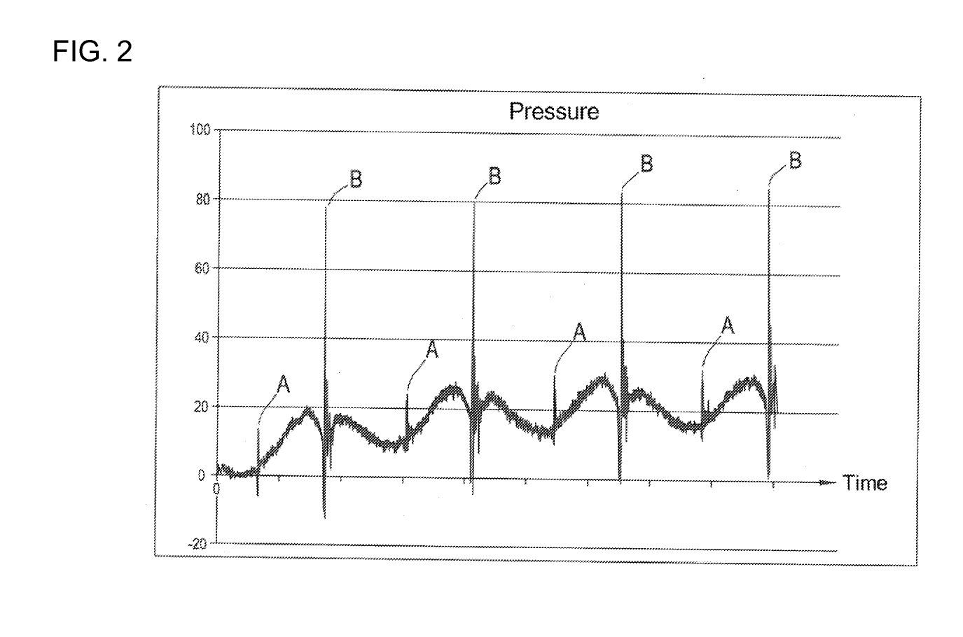

FIG. 2 shows signals from a sensor when passing through the first and the second nip; and

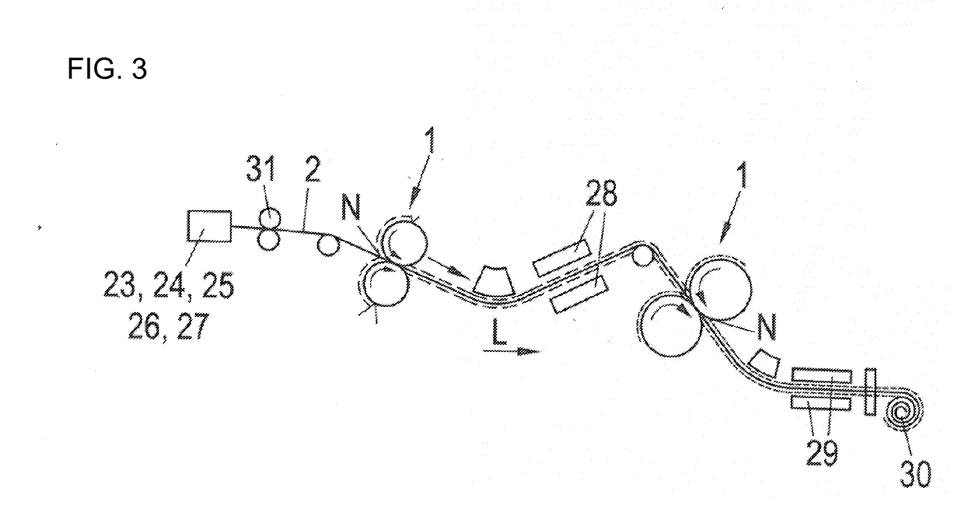

FIG. 3 shows a paper or cardboard machine for carrying out the method according to the invention.

FIG. 1 shows a film application unit 1 according to the invention for applying a pasty or fluid coating medium 8 to a running fibrous web 2, in particular a paper or cardboard web, in the cross section.

The film application unit 1 shown in FIG. 1 has a first nip 3 through which the fibrous web 2 is guided and during passage therethrough is simultaneously coated on both sides with the coating medium. The first nip 3 is formed by two rollers 4, 5 bearing against one another. Both rollers 4, 5 of the roller pair are presently application rollers, such that the fibrous web 2 by way of the film application unit which is embodied in this manner is simultaneously coated on both sides 6, 7 with a coating medium 8.

As can be seen from FIG. 1, in order for the coating medium in the form of a film 9, 9′ to be provided in each case, each of the two application rollers 4, 5 is assigned in each case one application installation 10, 10′ and a doctor element 12, 12′ which together with the respective application roller 4, 5 forms a second nip 11, 11′ in such a manner that the coating medium 8 which is present in the form of a film 9 on the one application roller 4 is transferred from the one application roller 4 in the second nip 3 to the one side 6 of the fibrous web 2, while the coating medium 8 which is present in the form of a film 9′ on the other application roller 5 is transferred from the other application roller 5 in the second nip 3 to the other side 7 of the fibrous web 2. As a result, a bilaterally coated fibrous web 2 exits the first nip 3.

Presently, the application installation 10, 10′ assigned in each case to one application roller 4, 5, and the doctor element 12, 12′ are disposed on a common support beam 13, 13′. Furthermore, each of the doctor elements 12, 12′ is presently configured as a doctor bar.

Presently, a plurality of pressure sensors 14, 14′ (of which in each case only one pressure sensor 14, 14′ is identifiable in FIG. 1) which in the machine cross direction are disposed beside one another are in each case embedded in the elastic covering of each application roller 4, 5, by way of which pressure sensors the pressure profile in the machine cross direction in the first nip 3 and in the two second nips 11, 11′ is ascertainable.

The pressure sensors 14, 14′ are presently configured as fiber-optic sensors, in particular as Bragg grating sensors. In the concept of the invention it would however also be possible for the pressure sensors 14, 14′ to be configured as piezo sensors. Presently, all pressure sensors 14, 14′ in each application roller 4, 5 are disposed along a straight line which runs parallel with the rotation axis of the rollers.

In the film application unit 1 shown in FIG. 1, the line force which is measured by the pressure sensors 14, 14′ in the second nips 11, 11′ is than the line force which is measured in the first nip 3, wherein a line force in the second nip 111, 11′ in the range of 5 kN/m to 50 kN/m and a line force in the range of 60 kN/m to 200 kN/m in the first nip are ascertained by the pressure sensors 14,14′.

Each of the application rollers 4, 5 has a roller core 20, 20′, the sleeve surface of which is surrounded by the covering, wherein the covering comprises a functional layer 21, 21′ which is capable of being brought in contact with the coating medium 8, and when viewed in the radial direction of the covering, a connecting layer 22, 22′ which is disposed between the functional layer 21, 21′ and the roller core 20, 20′, wherein the pressure sensors 14, 14′ are presently disposed in the barrier area between the functional layer 21, 21′ and the connecting layer 22, 22′. In the present exemplary embodiment the functional layer 21,21′ is of polyurethane, having a hardness in the range of 80 Shore A, whereas the connecting layer 22, 22′ is a fiber-composite layer of epoxy resin and glass fibers, having a hardness of 90 Shore D. The connecting layer 22, 22′ is thus harder than the functional layer 21, 21′.

When the pressure sensors 14, 14′ pass through the respective nip 3, 11, 11′, each of the pressure sensors corresponding to the influence of pressure in the nip generates one or a plurality of signals which is/are transmitted by said pressure sensors to an evaluation unit 15. Presently, the evaluation unit 15 is disposed so as to be entirely outside the application rollers 4, 5. However, there are also constructive designs in which parts of the evaluation unit are connected in a rotationally fixed manner to the respective roller, and other parts are disposed outside the roller, that is to say are not connected in a rotationally fixed manner to the respective roller. Presently, the signals of the pressure sensors 14, 14′ are transmitted in a wireless manner to the evaluation unit.

The signals emanating from the pressure sensors 14, 14′ are then further processed in the evaluation unit 15 in such a manner that said signals by means of a display unit 18 are capable of being visually represented as the pressure profile 16 of the first nip and 17,17′ of the two second nips 11, 11′.

In order for the rotational position of the two application rollers 4, 5 to be determined, a signal generator 19, 19′ which communicates with the evaluation unit 15 and which emits signals which are characteristic of the rotational position of the respective application roller 4, 5 to the evaluation unit 15 is provided in each of the application rollers 4, 5, from which the evaluation unit 15 ascertains an assignment of the signals of the pressure sensors 14, 14′ to the passage of the respective pressure sensors 14, 14′ through the first nip 3 and the respective second nip 11, 11′. The signal generators 19, 19′ are presently embodied according to the principle of the Hall effect sensor.

FIG. 2 shows the signals for a plurality of revolutions of one of the application rollers 4, 5, which signals are measured by the pressure sensors 14, 14′ when passing through the first nip 3 and through one of the second nips 11, 11′. Here, the signals A are generated by the pressure sensors 14, 14′ when passing through the second nip 11, whereas the signals B are generated by the pressure sensors 14, 14′ when passing through the first nip 11. The line force acting on the pressure sensor 14, 14′ here is proportional to the peak-to-peak values of the signals A, B of the pressure sensors 14, 14′, which are shown in FIG. 2. With respect to the details pertaining to the evaluation of the signals of the pressure sensors 14, 14′, reference is made to the German patent application no. 10 2012 206 689.6, the contents of which in this context are incorporated in their entirety in this application.

FIG. 3 shows a machine for manufacturing a coated fibrous web, in particular a paper or cardboard machine, having a headbox 23, a forming section 24, a pressing section 25, a drying section 27 comprising drying cylinders 26, and a plurality of application units 1, both film application units of which correspond to the film application unit shown in FIG. 1. By way of the machine shown in FIG. 3, a method for manufacturing a coated fibrous web 2 may be carried out as follows:
forming the fibrous web 2 from a fibrous mixture, using the headbox 23 and the forming section 24;
dewatering the fibrous web in the pressing section 25;
pre-drying the fibrous web to a specific dry content in a pre-drying section of the drying section 26, 27;
pre-smoothing the pre-dried fibrous web in a finishing unit 31;
bilateral application of a pigment-containing coating medium 8 by means of a film application unit 1 which is known from FIG. 1;
drying the unilaterally coated fibrous web 2 by means of an infrared dryer 28; and
at least unilateral application of a pigment-containing coating medium 8 by means of a film application unit 1 which is known from FIG. 1; and again
drying the coated fibrous web 2 by means of a further infrared dryer 29; and
rolling up the fibrous web 2.

As can be seen from the illustration of FIG. 3, application of the coating medium 8 is performed in-line on the machine by means of both film application units 1. In the illustrated machine, manufacturing of the fibrous web furthermore is performed at a machine speed of 1200 meters/minute or more, in particular at a machine speed of 1500 meters/minute or more.

1-19. (canceled)

20. A film application unit for applying a pasty or fluid coating medium to a running fibrous web, the film application unit comprising:
a first roller pair forming a first nip through which the fibrous web is guided, said first roller pair including at least one application roller for transferring the coating medium in the first nip from the application roller to a side of the fibrous web coming into contact with said application roller;
an application installation and a doctor element operatively associated with said application roller, said application installation applying, prior to said first nip, the coating medium excessively to said application roller and said doctor element, which together with said application roller forms a second nip, partially removing the coating medium in the second nip in order to form a film of coating material on the application roller; and
a plurality of pressure sensors embedded in an elastic covering of said application roller, said pressure sensors being disposed one beside another in a machine cross direction for ascertaining a pressure profile in the machine cross direction in the first nip and in the second nip.

21. The film application unit according to claim 20, which comprises an evaluation unit connected to communicate with said pressure sensors, and a display unit connected to communicate with said evaluation unit, wherein signals emanating from said pressure sensors are transmitted to said evaluation unit and further processed in said evaluation unit to enable the signals to be visually displayed by way of said display unit in the form of a pressure profile of the first nip and the second nip.

22. The film application unit according to claim 20, wherein both rollers of said roller pair are application rollers, wherein, in order for a film of the coating medium to be in each case provided on the respective application roller, each of said application rollers is assigned a respective said application installation and a doctor element which together with the respective said application roller forms a second nip, such that the coating medium which is present in the form of a film on the one application roller in the second nip is transferable from the one application roller to the one side of the fibrous web, and in that the coating medium which is present in the form of a film on the other application roller in the second nip is transferable from the other application roller to the other side of the fibrous web.

23. The film application unit according to claim 22, wherein said pressure sensors are embedded in the elastic covering of both said application rollers and in the machine cross direction are disposed beside one another, and the pressure profile in the machine cross direction is ascertainable by way of said pressure sensors and of said evaluation unit in at least one of said first nips, in both said second nips, and/or in said first nip.

24. The film application unit according to claim 20, wherein at least one of said application rollers has a signal generator configured to communicate with said evaluation unit and to transmit signals that are characteristic of a rotational position of said application roller to said evaluation unit, and wherein said evaluation unit ascertains from the signals an assignment of the signals of the pressure sensors to a passage of a respective said pressure sensors through said first and second nips.

25. The film application unit according to claim 20, wherein said pressure sensors are fiber-optic sensors.

26. The film application unit according to claim 20, wherein said pressure sensors measure a lower line force in said second nip than in the first nip.

27. The film application unit according to claim 26, wherein said pressure sensors are configured to ascertain a line force in a range of 5 kN/m to 50 kN/m in the second nip, and a line force in a range of 60 kN/m to 200 kN/m in the first nip.

28. The film application unit according to claim 20, wherein at least one of said application rollers has a roller core with a jacket surface surrounded by said covering, wherein said covering comprises a functional layer capable of being brought into contact with the coating medium, and when viewed in a radial direction of said covering a connecting layer which is disposed between said functional layer and said roller core, and said pressure sensors are disposed in a barrier region between said functional layer and said connecting layer.

29. The film application unit according to claim 28, wherein said connecting layer is harder than said functional layer.

30. The film application unit according to claim 28, wherein said connecting layer is harder than said functional layer by a factor of 10 to 100.

31. The film application unit according to claim 20, wherein said doctor element is a doctor bar or a doctor blade.

32. The film application unit according to claim 20, wherein all of said pressure sensors are disposed along a straight line extending parallel with a rotation axis of said rollers.

33. The film application unit according to claim 20, wherein the coating medium is a pigment-containing or starch-containing mixture.

34. A method of applying a liquid or pasty coating medium to at least one side of a running fibrous web, the method comprising:
applying the coating medium excessively to an application roller ahead of a second nip that is formed by the application roller and a doctor element and subsequently removing the coating medium partially in the second nip in order to form a film of the coating medium on the application roller; and
subsequently transferring the film in a first nip from the application roller to a side of the fibrous web coming into contact therewith; and
ascertaining a pressure profile that is established in the machine cross direction in the first nip and in the second nip by way of pressure sensors embedded in a covering of the application roller.

35. The method according to claim 34, which comprises ascertaining the pressure profile prior to and/or during an application of the coating medium to the fibrous web.

36. The method according to claim 34, which comprises ascertaining the pressure profile in the first and second nips by way of pressure sensors which are embedded in the covering of the application roller, which in the machine cross direction are disposed beside one another, and which are connected to communicate with an evaluation unit.

37. The method according to claim 34, which comprises coating the fibrous web simultaneously with the coating medium on both sides thereof by two application rollers that are provided by a roller pair forming the first nip therebetween, wherein the coating medium is excessively applied to the respective application roller prior to a second nip which is formed by the respective application roller and a doctor element assigned thereto, and in order for a film of the coating medium to be configured on the respective application roller, is again partially removed in the respective second nip by the respectively assigned doctor element, and the film subsequently in the first nip is transferred by the respective application roller to that one side of the fibrous web which in each case comes into contact with the respective application roller, wherein the pressure profile which is established in the machine cross direction in the respective first nip and in the second nip is ascertained by way of pressure sensors which are embedded in the covering of the respective application roller.

38. A method of manufacturing a coated fibrous web, the method comprising the following steps:
forming the fibrous web from a fibrous mixture, using a headbox and a forming section;
dewatering the fibrous web in a pressing section;
pre-drying the fibrous web to a specific dry content;
performing the method according to claim 33 to effect multiple applications of a coating medium;
post-drying the coated fibrous web;
wherein at least one application of a coating medium is performed in-line on the machine and the fibrous web is manufactured at a machine speed of at least 1200 meters per minute.

39. The method according to claim 38, wherein the fibrous web is a printable fibrous web, and the method comprises applying a pigment-containing coating medium to the fibrous web at least in one application.
